(19) United States
(12) Patent Application Publication
(10) Pub. No.: US 2026/0218983 A1
(43) Pub. Date: Jul. 30, 2026

(54) GRANULAR SOLIDS COOLING LINE

(71) Applicant: FIVES FCB, VILLENEUVE D'ASCQ (FR)

(72) Inventors: Joaquin ARBOS, VILLENEUVE D'ASCQ (FR); Geovanni CALDERON, VILLENEUVE D'ASCQ (FR)

(21) Appl. No.: 19/149,721

(22) PCT Filed: Jan. 19, 2024
(86) PCT No.: PCT/EP2024/051229

§ 371 Date: Jul. 21, 2025

(30) Foreign Application Priority Data
Jan. 26, 2023 (FR) FR2300732

(51) Int. Cl. F27B 7/38; C04B 7/47

(52) U.S. Cl. CPC F27B 7/386; C04B 7/47

(57) ABSTRACT

A line for cooling hot granular solids, the temperature of which is greater than 1000° C., the cooling line comprising in particular: a first cooler which is provided with at least one grate intended to receive the granular solids; a second cooler which is arranged downstream of the first cooler in the direction of movement of the granular solids, said second cooler being rotatable and comprising a material inlet through which the granular solids enter and a material outlet through which the granular solids leave, said cooling line being configured so that the granular solids move successively from the first cooler to the second cooler.

### TECHNICAL FIELD OF THE INVENTION

The invention relates to a cooling line as well as a cooling method implementing same. More concisely, the invention relates to a cooling line for granular solids, the temperature of which is greater than 1000° C. In particular, the invention relates to the cement production industry, and the granular solids are clinker intended for cement production.

### TECHNICAL BACKGROUND

Cooling lines are an integral part of cement production.

Clinker is a constituent of cement which is produced from a mixture of limestone and aluminosilicates.

Clinkerization is the step during which the mixture of limestone and aluminosilicates becomes clinker. Depending on the production site and surrounding geology, this step is carried out at a temperature of around 1500° C.

Clinkerization takes place in a rotary kiln. Once the clinker has been obtained, it must be cooled. This cooling takes place in a cooling line.

Cooling lines comprising for example grate coolers exist.

These cooling lines are particularly energy-intensive from an electrical point of view, due to the use of ventilation devices blowing through grates which have high pressure losses.

In a context of reducing the environmental impact of clinker production plants, the cooling lines are a potential energy-saving item.

The invention aims to reduce the energy consumption of cooling lines in order to improve the overall energy efficiency of clinker production installations.

### SUMMARY OF THE INVENTION

For this purpose, first proposed is a cooling line for hot granular solids, the temperature of which is greater than 1000° C., the cooling line comprising:
a first device for producing a first flow of cooling air,
a first cooler equipped with at least one grate intended to receive the granular solids, said grate being able to be traversed by the first flow of cooling air,
a second cooler arranged downstream of the first cooler in the direction of movement of the granular solids, said second cooler being rotatable and comprising a material inlet through which the granular solids enter and a material outlet through which the granular solids leave and in which a second cooling air stream circulates,
   the cooling line being configured so that the granular solids move successively from the first cooler to the second cooler, said cooling line comprising an air extraction circuit including an air extraction device, the air extraction circuit being able to produce in part said second flow of cooling air,
   the air extraction device being able to extract a first fraction of the second flow of cooling air.

The cooling line ensures sufficient cooling efficiency. The cooling line further makes it possible to optimize the consumption of electrical energy required for its operation and also to recover at least some of the thermal energy present in the clinker.

Various additional features can be provided alone or in combination:
the cooling line is arranged so that a second non-extracted fraction of the second air flow mixes with the first air flow in the first cooler to obtain a mixture;
the cooling line comprises means for recovering the mixture;
the air extraction device is configured to extract the air from inside the second cooler;
the air extraction device comprises an extraction end arranged inside the second cooler;
the second cooler extends in an extension direction substantially parallel to a direction of movement of the granular solids, said second cooler extending over a length L measured in the extension direction, and wherein the extraction end is arranged in the second cooler at a distance D greater than or equal to 0.5 L measured in the extension direction from the material outlet and said extraction end;
the distance D is between 0.7 L and 0.95 L;
the extraction device comprises an extraction line arranged inside the second cooler, said extraction line extending substantially parallel to the second cooler;
the extraction line and the second cooler are substantially concentric;
the at least one grate of the first cooler is fixed;
the first cooler comprises at least one crusher for crushing the granular solids;
the first cooler comprises a first portion and a second portion, separated from each other by the crusher, the at least one fixed grate of each portion being inclined so that the granular solids move under the effect of the earth's gravity.

Secondly, a method is proposed for cooling granular solids by means of a cooling line as described above, which comprises the following operations:
circulation of at least a first air flow in the first cooler through the at least one fixed grate,
circulation of a second air flow in the second cooler produced in part by the air extraction circuit connected to the material outlet,
extraction of a first fraction of the second air flow in the second cooler.

Various additional features can be provided alone or in combination:
the extraction step is performed so as to leave only a second fraction of the second air flow in the second cooler;
the second fraction of the second air flow is directed towards the first air flow to be mixed therewith, said mixture being recovered for subsequent use by means for recovering said mixture;
the first air flow contributes to a proportion of the mixture of between 50% and 60%, and the second fraction contributes to a proportion of the mixture of between 40 and 50%;
the first air flow contributes a proportion of the mixture of about 55%, and the second fraction contributes a proportion of the mixture of about 45%;
the first fraction extracted from the second air flow is between 65 and 80% of the second air flow.

### BRIEF DESCRIPTION OF THE FIGURES

Further features and advantages of the invention will become apparent from reading the following detailed description, for the understanding of which reference is made to the appended drawing, wherein:

FIG. 1 is a schematic depiction of a cooling line according to the invention.

### DETAILED DESCRIPTION OF THE INVENTION

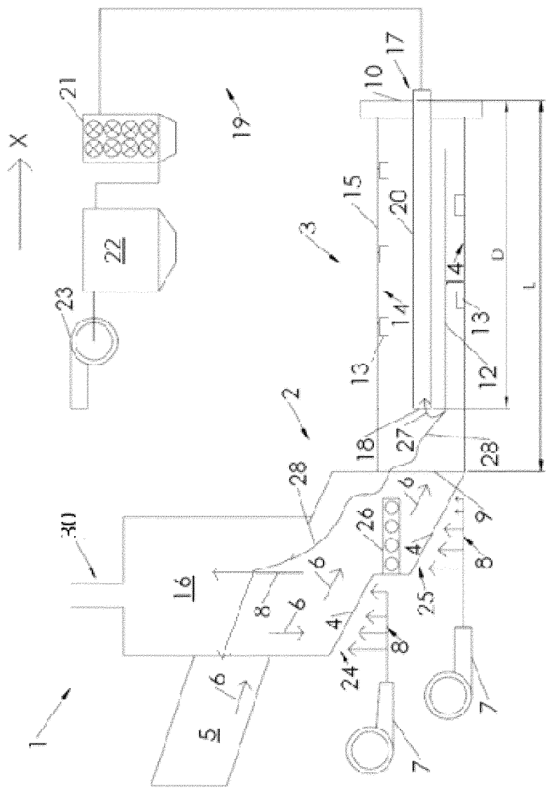

A cooling line 1 according to the invention is shown in FIG. 1.

The cooling line 1 comprises a first cooler 2 and a second cooler 3.

The first cooler 2 comprises several grates 4. These grates 4 are suitable for receiving granular solids. In this case, the granular solids are clinker heated to a temperature greater than 1000° C. in a kiln 5 adjacent to the first cooler 2.

As shown in FIG. 1, the grates 4 are inclined in the direction of movement of the clinker, said direction of movement is represented by movement arrows 6. This incline allows the clinker to move in the first cooler 2 under the effect of gravity and its geometric shape, which is substantially spherical.

The cooling line 1 comprises at least a first device 7 for producing a first cooling air flow 8. The first device 7 for producing the first air flow 8 is arranged so that the first cooling air flow 8 passes through the grates 4. Thus, the first air flow 8 can pass through the grates 4. The grates 4 take the form of perforated metal plates, the perforations of which are smaller than the clinker so that the latter cannot pass through the perforations.

The second cooler 3 is of the rotary type and is arranged downstream of the first cooler 2 in the direction of movement of the clinker. The second cooler 3 comprises a material inlet 9 through which the clinker leaving the first cooler 2 enters and which adjoins the first cooler 2. The second cooler 3 comprises a material outlet 10 through which the clinker leaves.

The cooling line 1 advantageously comprises an air extraction circuit 19 able to partially produce a second flow 12 of cooling air. To this end, the air extraction circuit 19 comprises:
an air extraction device 17 able to extract a fraction of the second flow 12 of cooling air, and
an extraction fan 23.

As shown in FIG. 1, the air extraction circuit 19 further comprises an extraction line 20, a heat exchanger 21, and a filter 22. The extraction line 20 is in fluid communication with the heat exchanger 21. The heat exchanger 21 is in fluid communication with the filter 22. The filter 22 is in fluid communication with the extraction fan 23.

The heat exchanger 21 is an emergency heat exchanger to protect the filter 22 from possible over-temperatures.

Thus, the extraction circuit 19, via the extraction fan 23 in particular, is able to partially produce the second flow 12 of cooling air by drawing air directly from the second cooler 3. Part of the second flow 12 of cooling air can then move in the second cooler 3 in the opposite direction to the movement of the clinker, that is, against the flow of materials circulating in the second cooler 3 from the material inlet 9 to the material outlet 10.

The second cooler 3 is arranged substantially horizontally as shown in FIG. 1. The second rotary cooler 3 advantageously comprises lifters 13 arranged on an inner face 14 of a rotary drum 15 of said second cooler 3. These lifters 13 have a profile that allows the clinker to be re-suspended in the cooling air flow to improve heat exchange.

Thus, the cooling line 1 is configured so that the clinker moves successively from the first cooler 2 to the second cooler 3.

This arrangement which provides a first grate cooler 2 followed by a second rotary cooler 3 and wherein the extraction device 17 extracts a first fraction 27 from the second flow 12 of cooling air reduces power consumption while maintaining acceptable clinker cooling kinetics and excellent recovery efficiency of the thermal energy contained in the clinker. The first grate cooler 2 is energy-intensive from an electrical point of view as the first air flow 8 is sent at high pressure through the clinker bed spread over the grates 4. The first cooler 2 is therefore used to quench the clinker and rapidly bring it to a temperature slightly below 1000° C. Cooling is then completed in the second rotary cooler 3, which is less energy-intensive in terms of the power absorbed by the extraction device 17 or by any element connected to this extraction device 17. The extraction device 17 extracts the first fraction 27 from the second air flow 12, the other fraction, hereinafter second fraction 28, then preferably mixing with the first air flow 8 in the first cooler 2, in order to obtain a mixture with a flow rate and temperature suitable for use elsewhere in the clinker production process.

The cooling line 1 described hereinbefore allows, by virtue of these arrangements, significant electrical energy savings and an increase in the overall efficiency of the cement plant.

Preferably, the cooling line 1 advantageously comprises at least one heating hood 16 in the form of a cavity. In particular, the heating hood 16 is located where the grates 4 are located and where a mixture comprising the first air flow 8 and the second fraction 28 of the second air flow 12 occurs. Additionally, the cooling line 1 preferably further comprises one or more mixture recovery lines 30 which can be arranged at different points in line 1, above the first cooler 2, depending on the specific temperature requirements of the mixture to be recovered. In particular, they capture the mixture comprising the first air flow 8 and the second fraction 28 of the second air flow 12.

It should be noted that the second fraction 28 of the second air flow 12 is directed towards the first cooler 2 insofar as the first cooler 2 comprises a negative pressure zone produced, for example, by a furnace draft fan 5 and/or by the heating hood 16 and/or by the mixture recovery line(s) 30 to which mixture recovery elements are generally connected.

According to one embodiment, the air extraction device 17 is configured to extract air from inside the second cooler 3. More specifically, the extraction device 17 comprises an extraction end 18. The extraction end 18 is arranged inside the second cooler 3. The extraction of air by the extraction end 18 arranged at this point advantageously makes it possible to reduce the amount of air in the second air flow 12 before it mixes with the first air flow 8. Thus, the temperature of the mixture comprising the first air flow 8 and the second fraction 28 of the second air flow 12 is adequate for subsequent use in the cement production process.

The second cooler 3 extends in one direction, hereinafter referred to as the X axis. The X axis is horizontal.

According to one embodiment variant, the second cooler 3 takes the form of a tube rotatably mounted on fixed supports. The rotatably mounted tube has a slightly inclined slope, for example a slope of a few degrees, so as to allow the clinker in the second cooler 3 to move from the material inlet 9 to the material outlet 10. The second cooler 3 has a distance L measured between the material inlet 9 and the material outlet 10 and along the X axis.

According to one embodiment variant, the extraction end 18 is arranged in the second cooler 3 at a distance D measured along the X axis. The distance D is measured between the material outlet 10 of the second cooler 3 and the extraction end 18.

Advantageously, the distance D is greater than or equal to 0.5 L. By positioning the extraction end 18 at this distance D, the first fraction 27 of the second air flow 12 is extracted so that the second air flow 12 has had time to cool the clinker in the second cooler 3.

In a preferred embodiment, the distance D is between 0.7 L and 0.95 L. Advantageously, this distance D allows the clinker to be cooled efficiently and ensures that the remaining second fraction 28, which is intended to be mixed with the first air flow 8 in the first cooler 2, is at the correct temperature.

In the embodiment shown in FIG. 1, the extraction line 20 is arranged inside the second cooler 3. As can be seen, the extraction line 20 extends substantially parallel to the second cooler 3. This arrangement is advantageous in that it allows the extraction end 18 to be positioned inside the second cooler 3. In addition, this arrangement avoids complicating the architecture of the extraction circuit 19 by freeing it from the constraints inherent in the rotational movement of the rotating drum 15.

According to one embodiment, the extraction line 20 is in the form of a tube. The extraction line 20 and the second cooler 3 are substantially concentric, which further frees it from the constraints inherent in the rotational movement of the rotating drum 15. For example, a first part of the extraction line 20 and the rotating drum 15 are substantially concentric and rotate together, and a second part of the extraction line 20 is fixed with respect to the rotating movement of the rotating drum 15 and connected to the first part of the extraction line 20 by means of a rotating joint system.

The first cooler 2 comprises two portions 24, 25, namely a first portion 24 and a second portion 25. The first portion 24 and the second portion 25 each comprise one or more fixed grates 4. As can be seen from FIG. 1, the grates 4 are inclined so that the clinker moves under the effect of the earth's gravity, as previously mentioned.

The use of fixed grates 4 advantageously simplifies the operation of the cooling line 1 and improves the reliability thereof despite the high clinker temperature.

The cooling line 1 advantageously comprises a crusher 26. The crusher 26 is arranged between the first portion 24 and the second portion 25. The crusher 26 can be used to reduce the size of clinker grains, in particular crusting elements. The crusher 26 is arranged after the first portion 24 so that the clinker undergoes a temperature reduction in order to preserve the crusher 26 and prevent it from being used at excessively high temperatures.

In the following, the operation of the cooling line 1 will be described.

The clinker moves under the effect of gravity in the kiln 5, which is slightly inclined. The clinker then lands on the fixed grate 4 of the first portion 24 of the first cooler 2. Under the effect of gravity, the clinker moves and is crushed in the crusher 26. On leaving the crusher 26, the clinker falls onto the fixed grate 4 of the second portion 25 of the second cooler 3. The clinker moves into the second portion 25 of the first cooler 2 under the effect of gravity. The clinker then falls into the second cooler 3 where its temperature drop continues throughout its journey through the second cooler 3.

At least a first air flow 8 is produced by virtue of the first air production device 7. This first air flow 8 is sent through the fixed grate 4 of the first portion 24 and of the second portion 25. The first air flow 8 is sent at high pressure so that it can pass through the bed of clinker spread out on each fixed grate 4. This operation “quenches the clinker” so that its temperature drops rapidly below 1000° C. The first air flow 8 rises in temperature on contact with the hot clinker.

A second air flow 12 is generated by the air extraction circuit 19 and by the vacuum zone contained in the first cooler 2. This second air flow 12 is initiated in the second cooler 3 by the material outlet 10 as shown in the drawing.

In the second cooler 3, a first fraction 27 of the second air flow 12 is extracted. This extraction is performed via the extraction device 17 included in the air extraction circuit 19. The first fraction 27 of air which is extracted is sent to the heat exchanger 21. The first fraction 27 is then sent to the filter 22 to remove clinker dust, then discharged into the atmosphere.

According to an embodiment not shown in the figures, the energy, in particular thermal energy, of the first fraction 27 of the second air flow 12 is then recovered in the clinker or cement manufacturing process using known ad hoc devices. For example, the energy from the first fraction 27 of the second air flow 12 can be used to dry raw materials or fuels required for the clinker manufacturing process.

The second fraction 28 of the second air flow 12, which is preferably not extracted, enters the first cooler 2 where it mixes with the first air flow 8. This mixture is then recovered in the heating hood 16, and can also be recovered via one or more of the recovery lines 30. This air mixture has temperature and flow rate characteristics that make it suitable for use, for example, as an oxidizer feeding a kiln burner, a combustion chamber integrated into a clinker production line, or even a precalciner, significantly increasing the energy efficiency of the clinker manufacturing process.

According to one embodiment, the first air flow 8 contributes a proportion of the mixture of between 50% and 60%. The second fraction 28 contributes a proportion of the mixture of between 40 and 50%.

According to one embodiment, the first fraction 27 which is extracted from the second air flow 12 is between 65 and 80% of the second air flow 12.

In a preferred embodiment:
the first air flow 8 contributes a proportion of the mixture of about 55%;
the second fraction 28 contributes a proportion of the mixture of about 45%;
the first fraction 27 extracted from the second air flow 12 is about 73%.

In a preferred embodiment and by way of example:
the first air flow 8 injected has a volume flow rate of 0.5 Nm³/kg of clinker;
the second flow 12 of injected air has a volume flow rate of 1.5 Nm³/kg of clinker;
the first fraction 27 of the second air flow 12 is extracted at a flow rate of 1.1 Nm³/kg;
the second fraction 28 therefore has a flow rate of 0.4 Nm³/kg of clinker;
as a result, the mixture of the first air flow 8 and the second fraction 28 has a flow rate corresponding to their sum, that is, 0.9 Nm³/kg.

1. A line for cooling hot granular solids, the temperature of which is greater than 1000° C., the cooling line comprising:
a first device for producing a first flow of cooling air,
a first cooler equipped with at least one grate intended to receive the granular solids, said grate being able to be traversed by the first flow of cooling air,
a second cooler arranged downstream of the first cooler in the direction of movement of the granular solids, said second cooler being rotatable and comprising a material inlet through which the granular solids enter and a material outlet through which the granular solids leave and wherein a second flow of cooling air circulates,
said cooling line being configured so that the granular solids move successively from the first cooler to the second cooler, said cooling line comprising an air extraction circuit including an air extraction device, the air extraction circuit being able to produce in part said second flow of cooling air,
said air extraction device being able to extract a first fraction of the second flow of cooling air.

2. The cooling line according to claim 1, wherein said cooling line is arranged so that a second fraction not extracted from the second air flow mixes with the first air flow in the first cooler to obtain a mixture.

3. The cooling line according to claim 2, wherein said cooling line comprises means for recovering said mixture.

4. The cooling line according to claim 1, wherein the air extraction device is configured to extract air inside the second cooler.

5. The cooling line according to claim 4, wherein the air extraction device comprises an extraction end arranged inside the second cooler.

6. The cooling line according to claim 5, wherein the second cooler extends in an extension direction substantially parallel to a direction of movement of the granular solids, said second cooler extending over a length L measured in the extension direction, and wherein the extraction end is arranged in the second cooler at a distance D greater than or equal to 0.5 L measured in the extension direction from the material outlet and said extraction end.

7. The cooling line according to claim 6, wherein the distance D is between 0.7 L and 0.95 L.

8. The cooling line according to claim 1, wherein the extraction device comprises an extraction line arranged inside the second cooler, said extraction line extending substantially parallel to the second cooler.

9. The cooling line according to claim 8, wherein the extraction line and the second cooler are substantially concentric.

10. The cooling line according to claim 1, wherein the at least one grate of the first cooler is fixed.

11. The cooling line according to claim 1, wherein the first cooler comprises at least one crusher for crushing the granular solids.

12. The cooling line according to claim 11, wherein the first cooler comprises a first portion and a second portion, separated from each other by the crusher, the at least one fixed grid of each portion being inclined so that the granular solids move under the effect of the earth's gravity.

13. A process for cooling granular solids by means of a cooling line according to claim 1, which comprises the following operations:
circulation of at least a first air flow in the first cooler through the at least one fixed grate,
circulation of a second air flow in the second cooler produced in part by the air extraction circuit connected to the material outlet,
extraction of a first fraction of the second air flow in the second cooler.

14. The cooling process according to claim 13, wherein the extraction step is carried out so as to leave only a second fraction of the second flow of air in the second cooler.

15. The cooling process according to claim 14, wherein the second fraction of the second flow of air is directed towards the first flow of air to be mixed therewith, said mixture being recovered for subsequent use by means for recovering said mixture.

16. The cooling process according to claim 14, wherein the first air flow contributes to a proportion of the mixture of between 50% and 60%, and the second fraction contributes to a proportion of the mixture of between 40 and 50%.

17. The cooling process according to claim 16, wherein the first flow of air contributes a proportion of the mixture of about 55%, and the second fraction contributes a proportion of the mixture of about 45%.

18. The cooling process according to claim 14, wherein the first fraction extracted from the second air flow is between 65 and 80% of the second air flow.
